(19) United States
(12) Patent Application Publication
(10) Pub. No.: US 2025/0158542 A1
(43) Pub. Date: May 15, 2025

(54) ThermoElectric Recharging Using Waste-Heat For Demand Charge Reduction

(71) Applicant: Budderfly, Inc., Shelton, CT (US)

(72) Inventors: David Gerald Cannon, Farmerville, LA (US); Kenneth Buda, Scarsdale, NY (US); Ibhade Christopher Edewele Eigbobo, West Allis, WI (US); Jaan Leemet, Aventura, FL (US)

(21) Appl. No.: 18/947,013

(22) Filed: Nov. 14, 2024

Related U.S. Application Data
(60) Provisional application No. 63/548,452, filed on Nov. 14, 2023.

(51) Int. Cl. H02N 11/00; H02J 7/00; H05B 6/00

(52) U.S. Cl. CPC H02N 11/002; H02J 7/00; H05B 6/00

(57) ABSTRACT

A system for recuperating waste heat for charging backup batteries and/or driving electrical loads is presented using thermoelectric generators to perform battery charging, particularly in quick serve restaurants (QSRs). Machine learning is applied to estimating the availability of power from thermoelectric generating based devices and for predicting and planning for the use of the available stored energy for peak energy usage periods thus reducing demand charges.

### FILED OF THE INVENTION

The present disclosure relates generally to systems and methods for recuperating waste heat using thermoelectric devices to generate electricity. More particularly, use of thermoelectric devices in QSR (quick serve restaurants) applications is particularly beneficial as waste heat can abundantly be collected from the compressors of refrigeration units such as freezers, refrigerators, ice-makes, ice-cream machines as well as cooking related appliances such as cook top/fryer and other ventilators.

### BACKGROUND OF THE INVENTION

Thermoelectric devices are becoming more efficient through the utilization of materials such as indium and purified tin selenide along with other oxides, nitrides, and phosphides. Design advances in multi-layer thermoelectric designs or vertical pillar and planar architectures have increased efficiency, lowered cost, and made such devices available for a variety of temperature ranges. Numerous Peltier generator modules are readily available for purchase and can perform the function of converting temperature differentials to energy.

The rising cost of energy, a heightened call to action with energy reduction, and the improved efficiency and lowered cost of these thermoelectric devices have converged to enable applications offering cost effective solutions using heat conversion to generate electricity.

U.S. Pat. No. 10,291,156 to Wang teaches systems primarily suited to capturing energy from bleed air in aircraft does not consider the challenges of operating in a QSR kitchen environment, nor does Wang consider the systems and methods of switching between multiple systems to offer a charging system for batteries.

Chinese Patent CN102434256B of GM global technologies seeks to use thermoelectrics in connection with internal combustion engines and fails to disclose a method that can work across multiple temperature gradients and that can work in a QSR (quick serve restaurant) kitchen environment.

U.S. Patent Publication 20180128432 to Lang provides a thermoelectric device configured to harfest heat generated by LEDs and convert it into electrical energy and does not consider the use of waste heat or the challenges of using such devices in a QSR kitchen environment or for charging batteries in conjunction with other devices such as solar panels.

Chinese Patent CN107493059B to GE Aviation Systems LLC provides a solar-electrical system for aircrafts incorporating a thermoelectric generator thermally coupled to a photon enhanced thermionic emission generator and does not consider the needs of a QSR kitchen.

Thus, it would be beneficial to have a system that could benefit from the advances in thermoelectric devices to leverage their use to generate electricity from the waste heat generated by HVAC coils, kitchen vent systems, and refrigeration and other cooling devices commonly found in QSR locations. The energy harvested from these sources can be used to drive small electrical loads or to charge batteries in conjunction with a renewable energy generation system. This stored electricity can be used to offset peak demand or otherwise be used for the electrical needs of the location.

### SUMMARY OF THE INVENTION

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present system provides generation of electricity in fixed locations which tend to be dense with heat generating devices such as that found in restaurant kitchens and factory environments. QSR environments are densely packed into a small footprint often with many devices generating waste heat in close proximity of one another.

The resultant energy generated with more efficient thermoelectric generator devices can both offset the high energy cost of running a QSR establishment, but it can also be strategically used to recharge batteries and deploy these to offset peak demand, and reduce resultant demand charges. The impact to the energy budget can be significant, and with the reduced cost and availability of these devices make for a compelling ROI (return on investment) for such franchise owners.

What is desired then is a system and method that can generate electricity from waste heat using thermoelectric generating devices.

It is further desired to provide a system and method that can use this electrical energy generated to recharge backup batteries in conjunction with solar panels or other renewable energy sources.

Is it still further desired to provide a system and method that can leverage multiple heat sources from within a QSR including kitchen vents, air conditioning coils, and refrigeration condenser coils. Various adaptations of houses and hoods are contemplated made up of a series of thermoelectric generators which act together to create electricity from the thermal differences.

It is still further desired to provide a system that takes into account the additive current generated with a holistic approach to energy savings, storing this in batteries and utilizing it to offset energy peak usage to reduce demand charges. Further, such a system can continue to charge when other sources are limited such as solar on cloudy days, or wind generation on less windy days. Similarly, such a system relies on heat sources, and those that are most consistently used are generally preferred for configuring into the system.

These and other objects are achieved by providing thermoelectric electricity generation system at a food service location. The location includes a cooking element and a ventilation system configured to receive heated exhaust gasses from an area adjacent the cooking element and expel the heated exhaust gasses. A plurality of thermoelectric devices are in contact on a first side with the ventilation system at a location of the ventilation system which is heated by the heated exhaust gasses and a second side of the thermoelectric devices exposed to ambient air of the location. The thermoelectric devices are electrically connected to an electrical load and the plurality of thermoelectric devices configured to generate electricity when there is a temperature differential between the first and second sides.

In certain aspects, the load includes a battery. In other aspects, the load includes a controller, the controller comprising a processor with software executing thereon. In other aspects, the food service location is a kitchen. In other aspects, the food service location is a quick serve restaurant (QSR).

Other objects are achieved by providing a thermoelectric electricity generation system at a food service location, the location includes a refrigeration element, the refrigeration element including a fan and a condenser which is configured to expel heated air to the location. A plurality of thermoelectric devices are in contact on a first side with an exterior facing portion of an element adjacent the condenser which exterior facing potion is configured to be heated by the heated air from an interior facing portion of the element and a second side of the thermoelectric devices exposed to ambient air of the location which is cooler than the heated air. The thermoelectric devices are electrically connected to an electrical load and the plurality of thermoelectric devices configured to generate electricity when there is a temperature differential between the first and second sides.

In certain aspects the system includes a cooking element at the food service location and a ventilation system configured to receive heated exhaust gasses from an area adjacent the cooking element and expel the heated exhaust gasses. A second set of a plurality of thermoelectric devices are in contact on a first side of the second set of the plurality of thermoelectric devices with the ventilation system at a location of the ventilation system which is heated by the heated exhaust gasses and a second side of the second set of a plurality of thermoelectric devices is exposed to ambient air of the location. The second set of the plurality of thermoelectric devices are electrically connected to an electrical load and the plurality of thermoelectric devices configured to generate electricity when there is a temperature differential between the first and second sides of the second set of the plurality of thermoelectric devices.

In certain aspects a third set of a plurality of thermoelectric devices are in contact on a first side of the third set of the plurality of thermoelectric devices with an exterior side of second element which second element is warmed from an interior side by heated air from a second condenser of an air conditioning or dehumidification system which second condenser is positioned to expel air outside the location and a second side of the third set of the plurality of thermoelectric devices is exposed to ambient air outside the location. In other aspects, the load includes a battery. In still other aspects the load includes a controller, the controller comprising a processor with software executing thereon. In still other aspects the food service location is a kitchen. In still other aspects the food service location is a quick serve restaurant (QSR). In other aspects, the load includes a controller and a battery, the controller comprising a processor with software executing thereon, the controller configured to control charging and discharging of the battery and the controller is connected to one or more appliances at the location and is configured to discharge electrical energy stored in the battery to the one or more appliances.

In one configuration, a ventilation duct is created and placed in the ventilation output area of the exhaust near a compressor. A fan is utilized to blow air across the coils of the compressor, creating a stream of hot air. This compressor can be part of an HVAC system, refrigeration system, or of a similar compressor-based device such as an ice maker or ice cream maker. The duct length can be adjusted to accommodate the available space. Again, the inside of the duct receives the exhaust air which is blown by the coils of the compressor in order to provide cooling, allowing the compressor to run more efficiently. The exhaust air that comes through the duct has a high temperature, whereas the outside of the duct is in contact with the ambient air of the restaurant area which is airconditioned. This temperature differential allows the thermoelectric generator to generate an electric current which can be carried to a smart panel or energy management system and directed to a battery system or to power local devices on the premises directly. The use of the current generated can be deployed just as with any similar renewable energy source, and the examples herein are simply illustrative and should not be construed as limiting in any way.

In another configuration, a sleeve or panel is made up of multiple thermoelectric generators and placed over a kitchen hood ventilation system. In such a configuration, waste heat from the hot stove and cooking gas passing through the existing hood cause the temperature of the hood to rise. The thermoelectric generator panel or sleeve is in contact with this heated surface on one side, whereas the other side is exposed to the ambient air-conditioned space. The temperature differential between the heated exhaust gases and the internal air-conditioned ambient air allows the thermoelectric generator to create a charge, which is in turn carried to a smart panel or energy manager and then directed to a battery or used to power local resident devices. Like any renewable energy source, this charge can be used and directed as desired.

A smart panel is used in the configuration to allow the switching of this charge to variable sources, and also allows the switching in and out of the stored energy resident in the battery.

If an abundance of power is obtained, and the battery is fully charged, the smart panel can also direct the generated energy towards other resident devices which can use this charge and offset power used from the grid.

It is also possible to sell this excess energy back to the utility grid using a similar system such as solar, whereby credits for wholesale rates of energy are often provided and used to offset the bill. This varies by the utility in the local region and a central energy management system is used to select the most beneficial use of this energy.

The system forms an integral part of an overall energy management system which has the embedded knowledge of the billing models of the local utility and a holistic view of energy use at the premises. Through sensors and current transformers, the central utility is able to monitor energy usage at the site and detect peak periods and exercise controls over the existing equipment on site. Similarly, the central system is able to control the smart panel in such a way that it can deploy the stored energy at optimal times to reduce peak energy use and thus reduce demand charges, which in turn reduce the energy bill for the premises.

Other aspects and features of the present invention will become apparent from consideration of the following description taken in conjunction with the accompanying drawings.

### BRIEF DESCRIPTION OF THE DRAWINGS

FIG. 1 provides a functional flow diagram of the present system and method implemented in a quick serve restaurant.

FIG. 2 is a side view or a thermoelectric generator according to FIG. 1.

FIG. 3 is an additional functional flow diagram according to features of FIG. 1.

FIG. 4 is an additional functional flow diagram according to features of FIG. 1, showing an example computer system and architecture thereof.

FIG. 5 shows a process flow according to certain aspects of the system of FIG. 1.

FIG. 6 shows a process flow according to certain aspects of the system of FIG. 1.

### DETAILED DESCRIPTION OF THE INVENTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and/or components have not been described in detail so as not to unnecessarily obscure aspects of the embodiments.

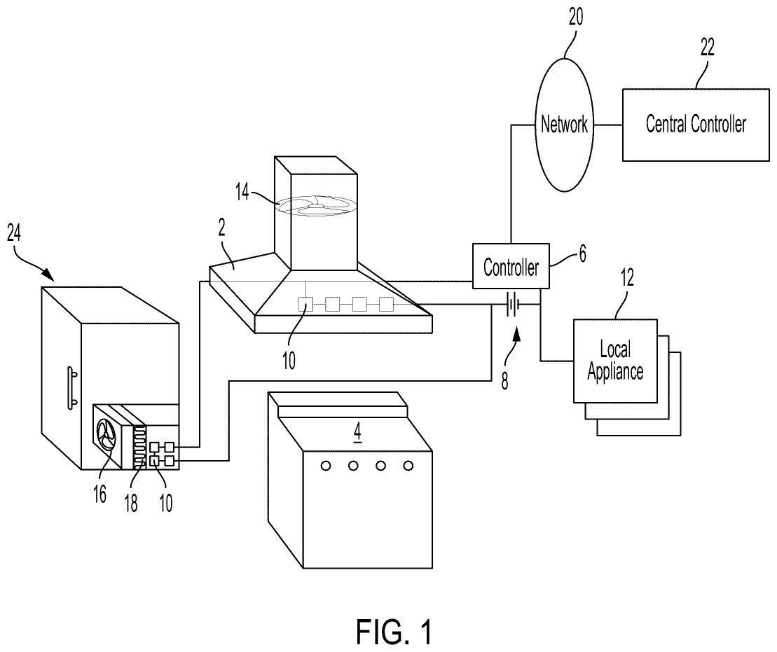

Referring to FIG. 1 an example quick serve restaurant (QSR) environment is shown. Specifically a range/oven 4 and a refrigerator 24 are shown, but it is understood that other cooking devices (e.g fryers, griddles, grills etc) and other cooling devices (e.g. ice makers, freezers, ice cream and ice drink makers) often found in QSRs can be sources or additional sources of captured heat. The range/oven 4 includes a vent hood 2 with a fan 14 therein. The hood will suck out hot exhaust gasses from the cooktop and as a result will become relatively warm/hot due to the exhaust gasses. The exterior of the hood 2 includes several thermoelectric devices 10, preferably with one side in contact with the exterior surface of the hood 2. Additional thermoelectric devices 10 are positioned to take benefit of heat coming off a condenser coil in a refrigeration unit 24. Namely, a fan 16 blows air over a condenser 18 of the refrigeration system and that now warmed air is blown out to the room environment (or through ducting). The thermoelectric devices are attached to the duct/exit surface such that one side is warmed by the heated duct/surface and the other side is exposed to the cooler room environment. As can be seen, there are several thermoelectric devices 10 connected together in series to a load which may include a controller 6 and a battery 8 and other local appliances 12. The controller provides a processor with software executing thereon and the controller controls whether the generated electricity is stored in the battery or used by other local appliances 12. The thermoelectric devices may also be arranged in parallel or a combination of parallel and series arrangements, depending on the desired voltage/current output. The controller is in communication with a central controller 22 via a network connection 20. The central controller also includes a processor with software executing thereon. The central controller may modify the behavior of the controller 6, for example based on efficiency needs, peak demand events and/or electricity rates.

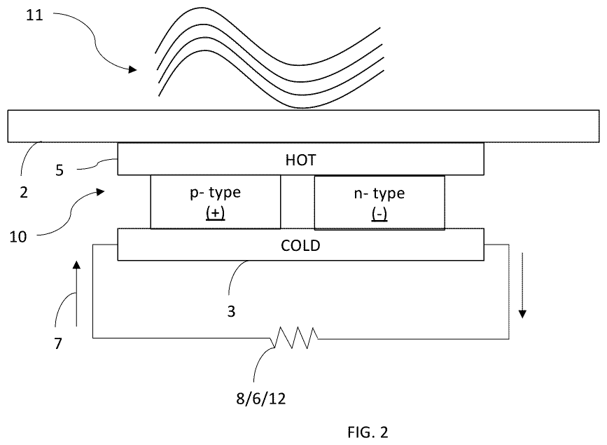

As shown in FIG. 2, additional detail on the thermoelectric devices 10 is shown where the hot side 5 of the thermoelectric device 10 is in contact with the exterior of the range hood 2 (or other heated exhaust element surface). The interior side of the range hood 2/exhaust element is heated by the warmed exhaust gases 11 which may be flue gasses from cooking or warmed air which has been forced over/through a condenser of a refrigeration system such as for a refrigerator/freezer or an air conditioner/dehumidifier. The cold side 3 of the thermoelectric device 10 is exposed to the ambient air, which may be an air conditioned space or may generally be cooler than the range hood or other warmed surface. In some cases, the ambient air may be exterior to the food service location in question, such as with air conditioners whose condensers/fans are placed outside. The thermoelectric device includes p-type and n-type semiconductors and as a result of the temperature differential, current 7 is created through the load 8/6/12. In FIG. 2, the load is shown simply as a resistor for ease of illustration, but is understood to be any number of electrical devices including the controller 6, battery 8, local devices 12 and components thereof.

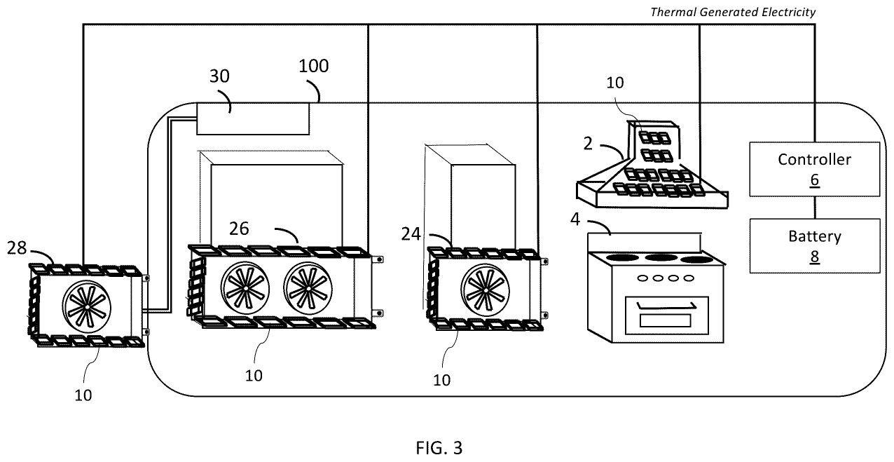

FIG. 3 shows an example where a cooktop 4 and vent hood 2, refrigerator 24, freezer 26 and exterior air conditioning compressor/condenser 28 are fitted with the thermoelectric devices. All of these are connected to the controller 6 and battery 8 and as in FIG. 1, the battery may power other local appliances 12. As can be seen, the AC compressor unit 28 has an interior cooling unit 30 which distributes cold air into the conditioned space 100 and the AC compressor is outside the kitchen/building 100. In this scenario, the temperature differential may be less between the hold and cold sides of the thermoelectric device or the cold side for the outside AC unit 28 may generally be warmer than within the conditioned space 100. As a result, the exterior thermoelectric devices may not generate as much electricity as those found inside the conditioned space 100.

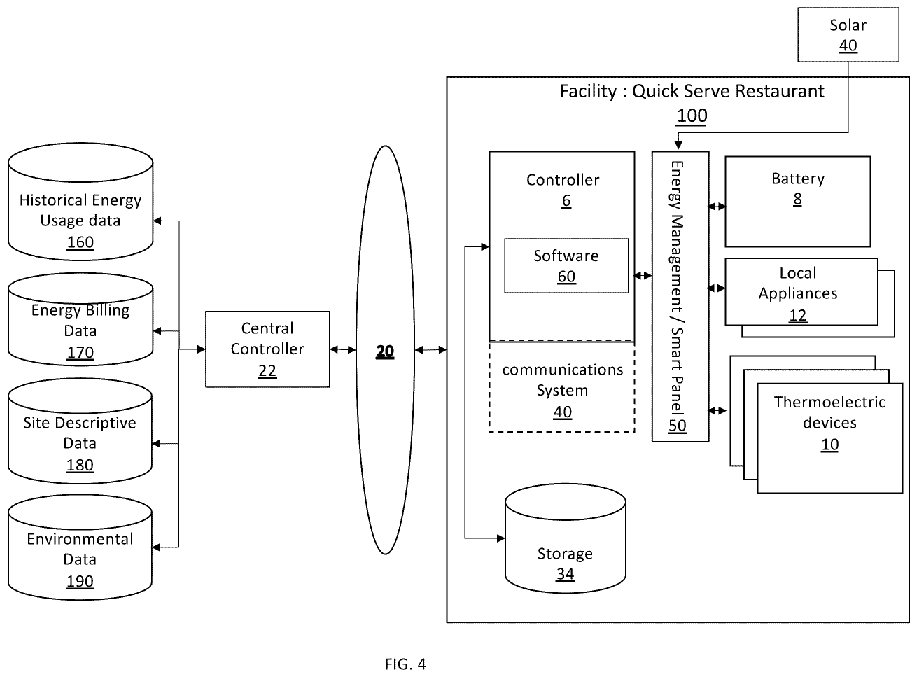

FIG. 4 depicts a high-level view of the components in the system. The controller 6 runs a local facility controller software 60 and is connected to storage 30 and a communications system 40.

The system connects to a smart panel 50 which in turn manages a battery system 8 and the local electrical loads 12. As part of the system, the thermoelectric devices 10 are also connected to the smart panel 50. Additional devices for renewable energy can also be connected to the panel 50 and controlled in a similar fashion.

Additionally, the controller 6 is connected through a network connection 20 to the central controller 20 (e.g. a central energy management system which in turn is connected to databases and external feeds that provide historical energy usage data 160, energy billing data 170 both current and historical, descriptive data about the site 180 such as the equipment available including appliances, sensors, and monitoring equipment. Finally environmental data 190 is used to predict energy needs and to correlate energy usage and efficiency with respect to current conditions. A solar array 40 may be connected to the energy management system/smart panel 50.

The facility controller software 20 to manages the power for local appliances 12 as well as the charging and discharging of the batteries 8. The energy manager 50 may or may not be part of the panel and also has potential inputs from other energy sources as well as the energy from the utility via the grid. In addition it may have other energy storage systems aside from batteries. The panel 50 and local facility controller and energy manager communicate through the network 20 with the central controller 22 which has knowledge of energy utilization history, environmental conditions, and billing models and data. This provides the intelligence to direct the system as to when to charge and discharge the batteries with maximal benefit for energy savings. The central controller 22 can also receive inputs from the utility such as an open ADR (advanced demand response) system which inputs can be used to modify the controller 6 algorithm/instructions based on demand events.

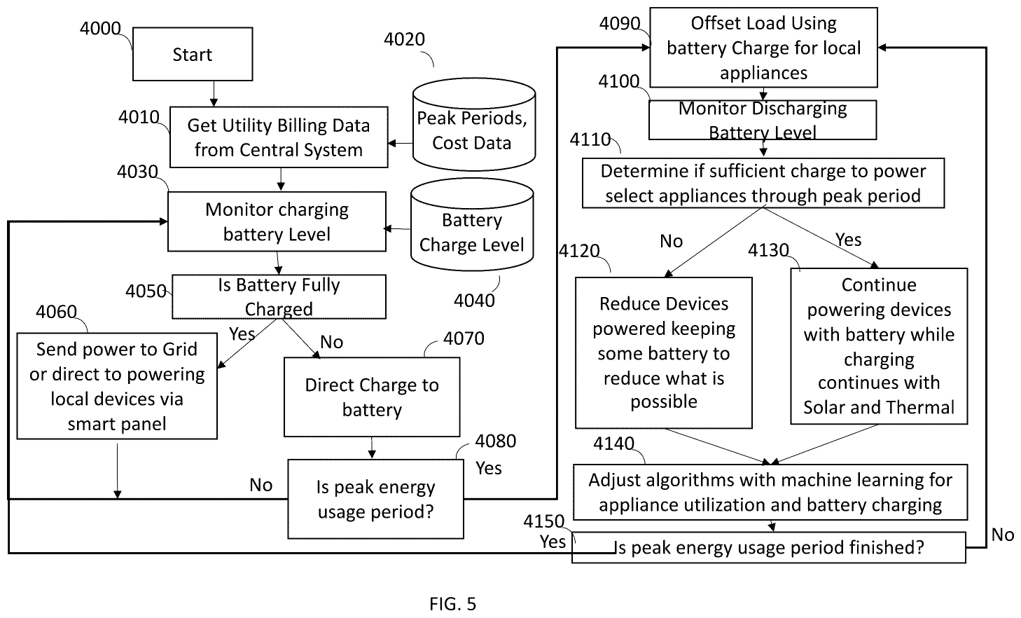

Turning now to FIG. 5, we see a sample logic flow of how the thermoelectric energy is used at the facility.

Upon start 4000 the system gets utility billing data 4010 from the central energy management system to obtain knowledge of peak periods 4020 and costing models used locally. The system them monitors 4030 the battery level 4040 and if the battery is fully charged 4050 can send power to the grid 4060 to obtain billing credits if this is allowed, or it can also direct the battery energy to powering local devices to offset the current energy consumption from the grid. A cost benefit analysis is made weighing the savings of offsetting current consumption, versus keeping the charge to offset an upcoming peak energy period, versus obtaining credits off the bill and further reducing costs.

If not fully charged 4050 the system directs energy provided 4070 by the solar and thermal systems to the battery.

If a peak energy usage period is present or upcoming, the system will offset load using the battery charge 4090 while it continued to monitor battery level 4100. If sufficient charge remains to power select appliances 4110 through the peak period 4130 it continues to do so. If not 4120 it reduced the power deployed to some devices selectively keeping sufficient power in reserve to meet some demand during the peak interval period.

The system also adjusts its machine learning algorithms 4140 regarding how the stored battery power can be utilized most efficiently, how long it lasts under certain conditions. This adjustment is later applied to systems that determine which appliances are reduced 4120 or continued to be powered 4130 through the peak periods. The machine learning aspects also apply to knowing how much energy can be generated over time and over certain periods. While solar can be somewhat predicted with weather forecasting, the thermal energy is predicted by business activity such as cooking in the case of kitchen hood systems. Even HVAC systems are affected by occupancy and other sensors which cause the HVAC to run more than usual, thus costing more in HVAC energy cost, but generating more electricity through thermal energy generation. Even refrigerant systems may have to work harder as doors are opened more frequently, more ice is made and dispensed etc. These added functions cause the compressors to run more often generating more heat and thus result in additional heat related energy generation.

Once the peak power period is over 4150 the system goes back to charging the battery with the solar and thermal sources.

The machine learning aspects of the system monitor how much energy is produced based on time of day, day of week and additional sensor data obtained by the facilities controller as well as site specific information known by the central energy management systems. Many of these are both operations specific as well as site specific. In the case of a submarine sandwich making establishment, the volume of customers will determine how often bread is baked. The mix of how many hot submarines are ordered as compared to how many cold submarines will dictate how often the toaster must be run. An establishment that offers soups in a soup warming system and ice creme with an ice-cream making machine will generate additional heat as compared to one without. While the facilities controller may have access to sensor data such as occupancy sensors, the easiest measurement technique is simply to monitor the energy drawn from the thermoelectric generators correlated to these sensors as well as factors such as time of day or day of week. These techniques will show lunchtime and dinner time rushes as more generated heat due to the additional use of the appliances.

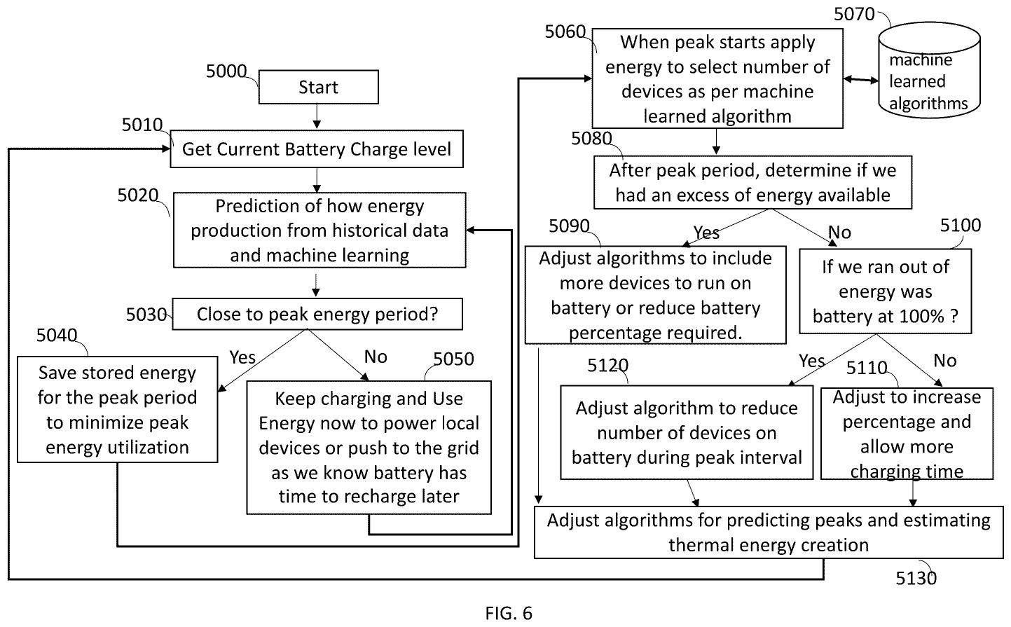

Turning to FIG. 6, we see some more details about the logic used in planning for the use of stored energy from the thermoelectric generator-based systems to reduce demand charges through the application of machine learning.

Upon starting 5000 the system retrieves the current battery charge 5010 and uses its algorithms to predict how long the energy will last 5020. This calculation takes into account the current charging rate as well as historical machine learned patterns for both energy use and energy generation. For example, the system knows from previously learned patterns that a lunch time rush in a restaurant will utilize X amount of energy and will generate Y amount of energy, the system can predict based on how close we are to the afternoon rush 5030 how much energy will be needed.

If we are not close to a peak period 5050 the system calculates how much time remains and if there is ample time to recharge the battery with the predicted rate of charge from current and learned charging rates. As such, the system can decide to either use some of the energy to power local devices or push energy back onto the grid for credits.

If, however, the peak usage period is imminent, the system saved the stored charge 5040 required for getting through the peak period. It should be noted that this is not necessarily 100% of the battery. If only ½ the battery is required to get through the upcoming peak, the system can still utilize the remaining ½ battery charge for other purposes. This 50% measurement is also fine-tuned with the machine learning algorithms and may vary in the future if the system determines insufficient charge or too much charge was remaining.

It should also be noted that there can be more than one peak and each peak may have different parameters. For example, the afternoon peak may require ½ of the battery but the evening peak when lights are also on, and additional heating required in winter may require 70% of the battery. There can be any number of peaks defined in the system and these are created through machine learning.

When the peak energy use period begins 5060 or when it is predicted based on the machine learned algorithms 5070, the system will utilize the battery to power a select number of devices.

After the peak period is completed 5080 the system takes stock of how its calculated energy budget held up to actual demand and usage. If an excess of energy was available 5090 then the algorithms are dynamically adjusted to include more devices on the battery, or the battery percentage required can be reduced.

If the system did not have sufficient charge 5100 the system determines if additional battery percentage can be allocated to the peak in question. If so, 5110 additional battery percentage is allocated and additional time for charging is configured into the algorithms. If the battery was already fully charged and fully allocated to the peak 5120 then the algorithm adjusts the number of devices powered during the peak to extend the batteries contribution across the peak period in question.

In all cases, the system learns about the actual battery usage during the most recent peak period as well as the charging rates of the various thermoelectric generators and adjusts its predictions for improved performance for the next peak period 5130. The system then returns to charging the battery and monitoring for the next expected peak.

While many of the examples above have been made in connection with QSR systems, similar factors can be considered when applied to various different types of applications that can generate waste heat.

Further, while the examples described herein primarily focus on the heat energy capture from heating vents and condenser coils, even solar heat, heat from stoves or other heating elements can be applied to generating the energy in a similar manner.

It will be understood by those of skill in the art that while examples using kitchen vents and condenser-based systems are utilized, the same system can be adapted and used for any systems that generate heat.

There are no limitations in terms of the particular embodiments described in this application, which are intended as illustrations of various aspects only. Many modifications and variations can be made without departing from its spirit and scope, as will be apparent to those skilled in the art. Functionally equivalent methods and apparatuses, in addition to those enumerated herein, will be apparent to those skilled in the art from the foregoing descriptions. Such modifications and variations are intended to fall within the scope of the appended claims. Only the terms of the appended claims are intended to be limiting, along with the full scope of equivalents to which such claims are entitled. It is also to be understood that the terminology used herein, e.g., “and”, “or”, “including”, “at least” as well as the use of plural or singular forms, etc., is for the purpose of describing examples of embodiments and is not intended to be limiting.

What is claimed is:

1. A thermoelectric electricity generation system comprising:
a food service location comprising a cooking element;
a ventilation system configured to receive heated exhaust gasses from an area adjacent the cooking element and expel the heated exhaust gasses;
a plurality of thermoelectric devices in contact on a first side with the ventilation system at a location of the ventilation system which is heated by the heated exhaust gasses and a second side of the thermoelectric devices exposed to ambient air of the location;
the plurality of thermoelectric devices electrically connected to an electrical load and the plurality of thermoelectric devices configured to generate electricity when there is a temperature differential between the first and second sides.

2. The system of claim 1 wherein the load includes a battery.

3. The system of claim 1 wherein the load includes a controller, the controller comprising a processor with software executing thereon.

4. The system of claim 1 wherein the food service location is a kitchen.

5. The system of claim 1 wherein the food service location is a quick serve restaurant (QSR).

9. A thermoelectric electricity generation system comprising:
a food service location comprising a refrigeration element, the refrigeration element including a fan and a condenser which is configured to expel heated air to the location;
a plurality of thermoelectric devices in contact on a first side with an exterior facing portion of an element adjacent the condenser which exterior facing potion is configured to be heated by the heated air from an interior facing portion of the element and a second side of the thermoelectric devices exposed to ambient air of the location which is cooler than the heated air;
the plurality of thermoelectric devices electrically connected to an electrical load and the plurality of thermoelectric devices configured to generate electricity when there is a temperature differential between the first and second sides.

10. The system of claim 9 further comprising
a cooking element at the food service location;
a ventilation system configured to receive heated exhaust gasses from an area adjacent the cooking element and expel the heated exhaust gasses;
a second set of a plurality of thermoelectric devices in contact on a first side of the second set of the plurality of thermoelectric devices with the ventilation system at a location of the ventilation system which is heated by the heated exhaust gasses and a second side of the second set of a plurality of thermoelectric devices is exposed to ambient air of the location;
the second set of the plurality of thermoelectric devices electrically connected to an electrical load and the plurality of thermoelectric devices configured to generate electricity when there is a temperature differential between the first and second sides of the second set of the plurality of thermoelectric devices.

11. The system of claim 10 further comprising:
a third set of a plurality of thermoelectric devices in contact on a first side of the third set of the plurality of thermoelectric devices with an exterior side of second element which second element is warmed from an interior side by heated air from a second condenser of an air conditioning or dehumidification system which second condenser is positioned to expel air outside the location and a second side of the third set of the plurality of thermoelectric devices is exposed to ambient air outside the location.

12. The system of claim 9 wherein the load includes a battery.

13. The system of claim 9 wherein the load includes a controller, the controller comprising a processor with software executing thereon.

14. The system of claim 9 wherein the food service location is a kitchen.

15. The system of claim 9 wherein the food service location is a quick serve restaurant (QSR).

16. The system of claim 10 wherein the load includes a controller and a battery, the controller comprising a processor with software executing thereon, the controller configured to control charging and discharging of the battery.

17. The system of claim 16 wherein the controller is connected to one or more appliances at the location and is configured to discharge electrical energy stored in the battery to the one or more appliances.

18. A thermoelectric electricity generation system comprising:
a food service location comprising a refrigeration element, the refrigeration element including a fan and a condenser which is configured to expel heated air to the location;
a plurality of thermoelectric devices in contact on a first side with an exterior facing portion of an element adjacent the condenser which exterior facing potion is configured to be heated by the heated air from an interior facing portion of the element and a second side of the thermoelectric devices exposed to ambient air of the location which is cooler than the heated air;
the plurality of thermoelectric devices electrically connected to a controller and a battery and the plurality of thermoelectric devices configured to generate electricity when there is a temperature differential between the first and second sides;
a cooking element at the food service location;
a ventilation system configured to receive heated exhaust gasses from an area adjacent the cooking element and expel the heated exhaust gasses;
a second set of a plurality of thermoelectric devices in contact on a first side of the second set of the plurality of thermoelectric devices with the ventilation system at a location of the ventilation system which is heated by the heated exhaust gasses and a second side of the second set of a plurality of thermoelectric devices is exposed to ambient air of the location;
the second set of the plurality of thermoelectric devices electrically connected to the controller and the battery and configured to generate electricity when there is a temperature differential between the first and second sides the second set of the plurality of thermoelectric devices;
the controller is connected to one or more appliances at the location and is configured to discharge electrical energy stored in the battery to the one or more appliances.
